(19) United States
(12) Patent Application Publication
(10) Pub. No.: US 2015/0055061 A1
(43) Pub. Date: Feb. 26, 2015

(54) TRANSFLECTIVE DISPLAY WITH COLOR SHIFT REDUCTION

(71) Applicant: MFLEX UK Limited, Comberton, Cambridge (GB)

(72) Inventors: Duncan Robert Johnston, Cambridge (GB); Christopher James Newton Fryer, Cambridge (GB)

(21) Appl. No.: 14/384,002

(22) PCT Filed: Mar. 15, 2013
(86) PCT No.: PCT/US2013/032019

§ 371 Date: Sep. 9, 2014

Related U.S. Application Data
(60) Provisional application No. 61/613,542, filed on Mar. 21, 2012.

(51) Int. Cl. G02F 1/1335; G02F 1/1334; G02B 1/04; G02B 5/02; G02B 5/22

(52) U.S. Cl. CPC G02F 1/133555; G02B 5/0289; G02B 5/22; G02B 1/04; G02F 1/1334; G02F 1/133621; G02F 1/133504; G02F 1/133514; G02F 2001/133614; G02F 2001/133624
USPC 349/71; 359/599

(57) ABSTRACT

A transflective display includes a substrate, a partially absorbing layer arranged on the substrate, a reflection layer arranged on the partially absorbing layer opposite to the substrate, and an emissive layer arranged on the reflection layer opposite to the partially absorbing layer. The emissive layer includes a plurality of light-emitting elements that emit light of at least one color and a dye of a color other than the at least one color of the plurality of light-emitting elements. The reflection layer is arranged to reflect some light from the emissive layer back into the emissive layer.

### BACKGROUND OF THE INVENTION

1. Field of the Invention

The present invention relates to transflective displays. More specifically, the present invention relates to transflective displays that use phosphors of one or two colors and a dye of another color.

2. Description of the Related Art

Conventional displays, such as liquid crystal displays (LCDs), operate in one of a reflective mode or a transmissive mode. In a reflective mode display, the display receives and reflects ambient light such that the source of light for the display is external to the display. In a transmissive mode display, the display receives light from a backlight, such that the source of light for the display is internal to the display. Although transmissive mode displays can be used in dark environments, they generally require more power and generate additional heat as compared to reflective mode displays. Reflective mode displays cannot be used in dark environments unless an external light source is provided, since they rely on ambient light for operation. Further, images on reflective mode displays may have undesirable color shifting or contrast issues, since light must pass through certain layers of the display twice (i.e., the layers between the light source and the reflective layer).

Transflective displays include both a reflective mode and a transmissive mode. Accordingly, transflective displays provide power savings and reduced heat generation as compared to displays that operate only in a transmissive mode, while providing an improved image compared to displays that only operate in a reflective mode and providing the ability to operate in dark environments. However, since light passes through different layers and different numbers of layers in a transflective display, depending on the amount of ambient light, a brightness setting of the backlight, internal reflections in layers of the display, etc., special considerations must be taken in designing the layers of the transflective display to prevent color shifting and to optimize brightness and contrast of the display.

Certain known emissive displays generate emitted colors by: (1) emitting light from an emissive element (e.g., a phosphor) of one color and (2) absorbing some of the emitted light with a fluorescent or phosphorescent dye, pigment, or phosphor and then emitting light at a different wavelength, typically a longer wavelength (i.e., closer to the red end of the visible light spectrum) in response to this absorption. For example, a known emissive display may include a mixture of a blue-emitting phosphor and/or a green-emitting phosphor with a red dye which absorbs some of the blue or green light and then emits red light. Typically, a concentration of red dye is selected so that the overall effect of the mixture of phosphor and dye is to produce output light that is substantially white in color.

However, two main problems arise with a mixture of phosphor(s) and dye when used in a transflective display. First, it is desirable that such a transflective display appears to emit substantially the same color in the transmissive and reflective modes so that a user may reliably use the display in varying ambient light conditions. A problem in known transflective displays that use a mixture of a blue-emitting phosphor and/or a green-emitting phosphor with a red dye as described above is that light reflected by the display in the reflective mode has a red tint because the blue-emitting phosphor and/or the green-emitting phosphor do not emit any light in the reflective mode, whereas the red dye absorbs blue or green light of the reflected light and then emits red light in the reflective mode.

Second, when the phosphor(s) and dye mixture is placed behind and in close proximity to a partially absorbing layer, for example, a polymer dispersed liquid crystal (PDLC) layer, emitted light in the transmissive mode has a blue and/or green tint.

When a partially absorbing layer is not present (for example, in a display that uses an electroluminescent (EL) lamp or in a display which does not have a transflective functionality), part of the blue and/or green light which is emitted from the phosphor layer in a direction towards the front of the display is internally reflected at the interface of the substrate and air. This reflected light passes back to the dyed phosphor layer, where it is partially converted to red light and re-emitted towards the front of the display at a random angle. This light may then pass out of the display, or, depending on the angle at which it meets the substrate-air interface, may again be internally reflected and further partially converted to red light.

An example of a known emissive display that does not include a partially absorbing layer is shown in FIG. 3A. FIG. 3A is a schematic view of a known display 110 that uses a blue and/or green light emitter with red dye. The display 110 includes an electrode layer 111, a light-emitting phosphor layer 113 (a blue-emitting phosphor and/or the green-emitting phosphor mixed with a red dye), and a substrate 116. The display 110 may also include a front electrode layer 111′ which, along with the electrode layer 111, can activate the phosphor(s) included in the light-emitting phosphor layer 113. As shown in FIG. 3A, emitted light 121 is emitted from the light-emitting phosphor layer 113 and into the substrate 116. A portion of the emitted light 121 passes though the substrate 116 and out of the display as output light 122. Some of the light is internally reflected back into the light-emitting phosphor layer 113 as internally reflected light 123. The internally reflected light 123 is partially absorbed by the red dye and re-emitted into the substrate 116, by reflecting off the electrode layer 111, as partially converted emitted light 124. As shown in FIG. 3B, a known emissive display 110′ may alternatively include a reflective dielectric 112, such that the internally reflected light reflects off the reflective dielectric 112 instead of the electrode layer 111. Because the red dye partially absorbs the internally reflected light 123 and then re-emits the light as red light, the partially converted emitted light 124 has a red tint compared to the internally reflected light 123. A portion of the partially converted emitted light 124 passes through the interface between the substrate 116 and air as partially converted output light 125, and another portion is again internally reflected (not shown) into the light-emitting phosphor layer 113. The display 110 relies on the internal reflections to produce light that is substantially white in color so that the total light output from the display 110 is substantially white in color.

However, when a partially absorbing layer is included in a display, for example, between a light-emitting phosphor layer and a substrate layer, the amount of light that is internally reflected in the display may be reduced.

An example of a known transflective display that includes a partially absorbing layer is shown in FIG. 4. FIG. 4 is a schematic view of a known display 130 that includes an electrode layer 131, a light-emitting phosphor layer 133 (a blue-emitting phosphor and/or the green-emitting phosphor mixed with a red dye), a partially absorbing layer 135, and a substrate 136. The display 130 may also include a front electrode layer 131′ which, along with the electrode layer 131, can activate the phosphor(s) included in the light-emitting phosphor layer 133. As shown in FIG. 4, emitted light 141 is emitted from the light-emitting phosphor layer 133 and into the partially absorbing layer 135. A portion of the emitted light 141 passes through the partially absorbing layer 135, the substrate 136, and out of the display as output light 142. Some of the light is internally reflected back into the light-emitting phosphor layer 133 through the partially absorbing layer 135 as internally reflected light 143. The internally reflected light 143 is partially absorbed by the red dye and re-emitted as red light from the light-emitting phosphor layer 133 into the partially absorbing layer 135 and the substrate 136 as partially converted emitted light 144. Because the red dye partially absorbs the internally reflected light 143 and re-emits that light as red light, the partially converted emitted light 144 has a red tint compared to the internally reflected light 143. A portion of the partially converted emitted light 144 passes through the interface between the substrate 136 and air as partially converted output light 145, and another portion is again internally reflected (not shown) into the light-emitting phosphor layer 133.

Since the internally reflected light 143 is attenuated twice by passing through the partially absorbing layer 135, the portion of the internally reflected light 143 that passes out of the display 130 as partially converted output light 145 is lower than the portion of the internally reflected light 123 that passes out of the display 110 as partially converted output light 125. Thus, the proportion of the total light output from the display 130 which is converted to red light is lower than the proportion of the total light output from the display 110 which is converted to red light. Accordingly, the light output from the display 130 is shifted towards blue and/or green light in the transmissive mode as compared to the light output from the display 110. However, attempting to mitigate the color shift effect of the display 130 by adding a higher concentration of red dye to the light-emitting phosphor layer 133 causes a reduced brightness of the total light output from the display 130 and an increased intensity of the red color of the display 130 in the reflective mode.

A further problem with transflective displays may arise whether or not a dye, such as the red dye described above, is included in the light-emitting layer of the display, such as the blue-emitting phosphor and/or green-emitting phosphor of the light-emitting phosphor described above. In particular, if the light-emitting layer is a diffuse emitter, such as a lambertian emitter, a substantial portion of light emitted by the light-emitting layer is emitted at an acute angle with respect to the substrate of the display and is thus subject to increased attenuation.

An example of another known transflective display that includes a partially absorbing layer is shown in FIG. 5. FIG. 5 is a schematic view of a known transflective display 150 that includes an electrode layer 151, a reflective dielectric 152, a light-emitting phosphor layer 153 (which may or may not include a dye), a partially absorbing layer 155, and a substrate 156. The display 150 may also include a front electrode layer 151′ which, along with the electrode layer 151, can activate the phosphor(s) included in the light-emitting phosphor layer 153. As shown in FIG. 5, a portion of the light emitted from the light-emitting phosphor layer 153 is emitted at an angle that is close to normal with the substrate 156 (i.e., at an angle of about 90° with respect to a surface of the display 150) as normal-emitted light 161. Further, another portion of the light emitted from the light-emitting phosphor layer 153 is emitted at an angle that is acute to the substrate 156 as acute-emitted light 164. The normal-emitted light 161 and the acute-emitted light 164 are emitted into the partially absorbing layer 155 where they are attenuated, and then pass through the substrate 156 and out of the display as normal-output light 162 and acute-output light 165 (internal reflections of the normal-emitted light 161 and acute-emitted light 164 are omitted from FIG. 5 for clarity).

Since the acute-emitted light 164 has a longer path through the partially absorbing layer 155 than the normal-emitted light 161, more of the acute-emitted light 164 is absorbed by the partially absorbing layer 155 than the normal-emitted light 161. Accordingly, the total amount of light output by the transflective display 150 is reduced when a diffuse light-emitting layer, in particular a lambertian light-emitting layer, is used as the light-emitting phosphor layer 153. The overall effect of the partially absorbing layer 155 is to reduce the total amount of light which is output from the display and to reduce the range of angles at which a user is able to view the display with clarity.

Furthermore, if the partially absorbing layer 155 is a PDLC layer, the absorbance of the partially absorbing layer 155 is greater for light which passes at an angle close to parallel to the substrate 156 than for light which passes at an angle close to normal to the substrate 156. This is due to a property of the PDLC. This increases the effect by which light passing as an angle close to parallel to the substrate is absorbed.

### SUMMARY OF THE INVENTION

To overcome the problems described above, preferred embodiments of the present invention provide a transflective display that achieves color shift reduction in both reflective and transmissive modes.

A transflective display according to a preferred embodiment of the present invention includes a substrate, a partially absorbing layer arranged on the substrate, a reflection layer arranged on the partially absorbing layer opposite to the substrate, and an emissive layer arranged on the reflection layer opposite to the partially absorbing layer. The emissive layer includes a plurality of light-emitting elements that emit light of at least one color and a dye of a color other than the at least one color of the plurality of light-emitting elements. The reflection layer is arranged to reflect some light from the emissive layer back into the emissive layer.

The plurality of light-emitting elements of the emissive layer are preferably light-emitting phosphors. The plurality of light-emitting elements of the emissive layer preferably includes a blue-emitting phosphor and/or a green-emitting phosphor, and the dye preferably is a red dye.

Preferably, a portion of light emitted by the emissive layer that is incident on the reflection layer passes through the reflection layer, the partially absorbing layer, and the substrate, and another portion of light emitted by the emissive layer that is incident on the reflection layer is internally reflected by the reflection layer. Light reflected by the reflection layer is preferably shifted to a longer wavelength by the emissive layer and re-emitted into the reflection layer.

An absorbance of the partially absorbing layer preferably increases as an angle of incident light becomes closer to parallel with respect to the partially absorbing layer. Preferably, the partially absorbing layer is electrically controlled. The partially absorbing layer is preferably a polymer dispersed liquid crystal layer.

The reflection layer preferably includes barium-titanate-loaded polyvinilidene fluoride. The reflection layer is preferably a diffuser layer. Preferably, the diffuser layer transmits about 60% to about 70% of incident light and scatters about 30% to about 40% of incident light. The reflection layer preferably has a dielectric constant between about 5 and about 50.

Preferably, the reflection layer is a metallic layer arranged to reflect some light from the emissive layer back into the emissive layer and to reflect some external light before entering the emissive layer.

The reflection layer preferably has an index of refraction of about 1.30 to about 1.45. Preferably, the substrate, the partially absorbing layer, and the emissive layer each have a refractive index between about 1.5 to about 1.6. The reflection layer is preferably a low-refractive-index layer that has a refractive index that is lower than each of the refractive indexes of the partially absorbing layer and the substrate.

Preferably, a portion of light emitted by the emissive layer that is incident on an interface between the emissive layer and the reflection layer passes through the interface, the reflection layer, the partially absorbing layer, and the substrate, and another portion of light emitted by the emissive layer that is incident on the interface between the emissive layer and the reflection layer is internally reflected by the interface.

The transflective display preferably further includes an electrode layer arranged on the emissive layer opposite to the reflection layer, and a transparent or substantially transparent front electrode layer arranged between the substrate and the partially absorbing layer. The electrode layer and the front electrode layer are preferably arranged to activate the plurality of light-emitting elements.

White light output by the transflective display preferably has color co-ordinates of x=0.33+/−0.05 and y=0.33+/−0.05 in the International Commission on Illumination (CIE) color space. The reflection layer and either the partially absorbing layer or the emissive layer are preferably provided in a single layer.

The above and other features, elements, characteristics and advantages of the present invention will become more apparent from the following detailed description of preferred embodiments of the present invention with reference to the attached drawings.

### BRIEF DESCRIPTION OF THE DRAWINGS

FIG. 1A is a schematic view of a transflective display according to a preferred embodiment of the present invention.

FIG. 1B is a schematic view of the transflective display of FIG. 1A further including a reflective dielectric.

FIG. 2 is a schematic view of another transflective display according to a preferred embodiment of the present invention.

FIG. 3A is a schematic view of a known emissive display using a blue and/or green light emitter with red dye.

FIG. 3B is a schematic view of the known emissive display of FIG. 3A further including a reflective dielectric.

FIG. 4 is a schematic view of a known transflective display with a partially absorbing layer.

FIG. 5 is a schematic view of a known transflective display with a partially absorbing layer.

### DETAILED DESCRIPTION OF PREFERRED EMBODIMENTS

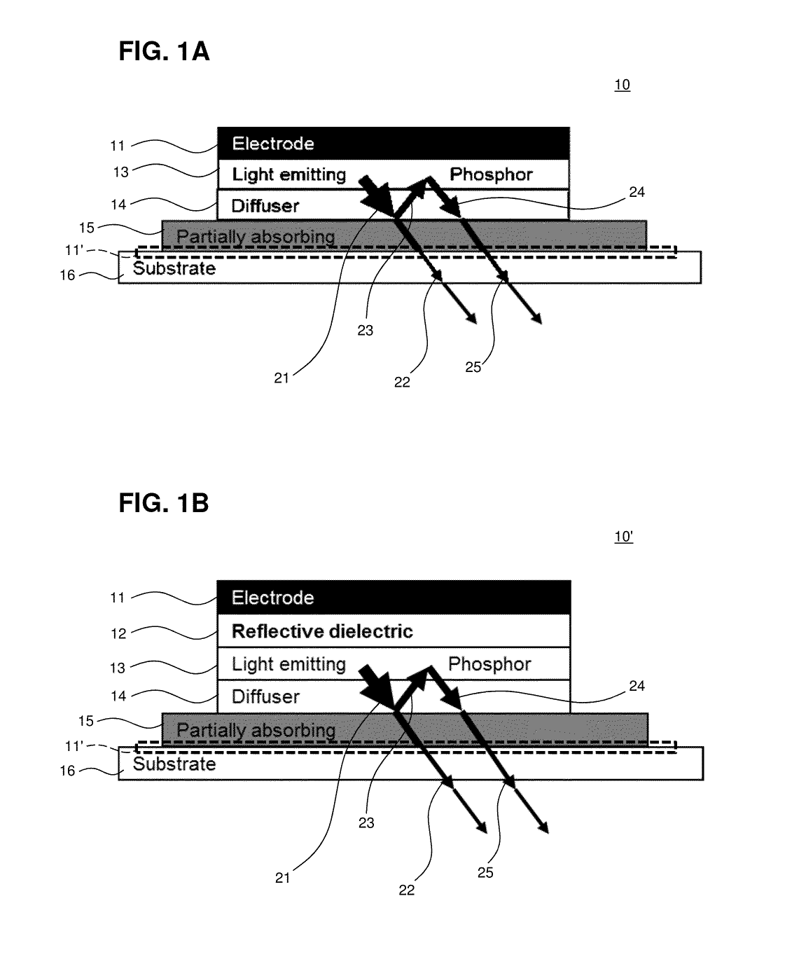

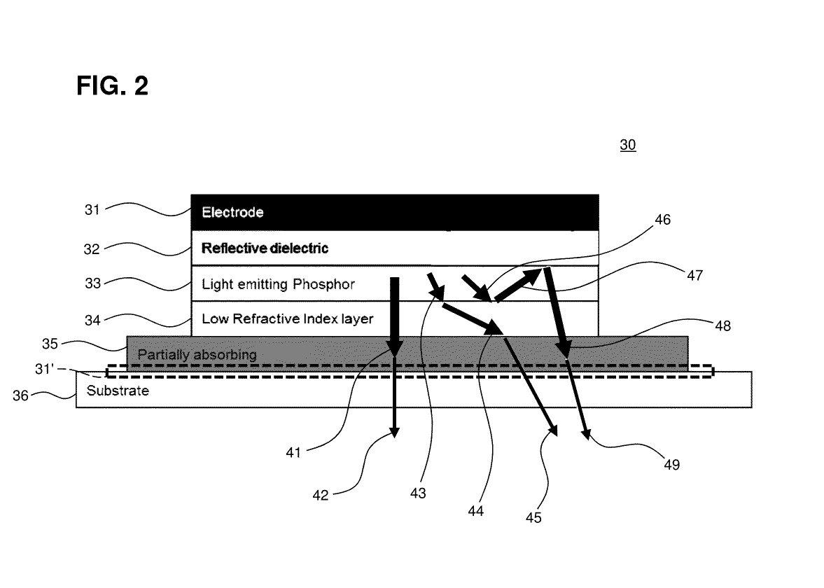

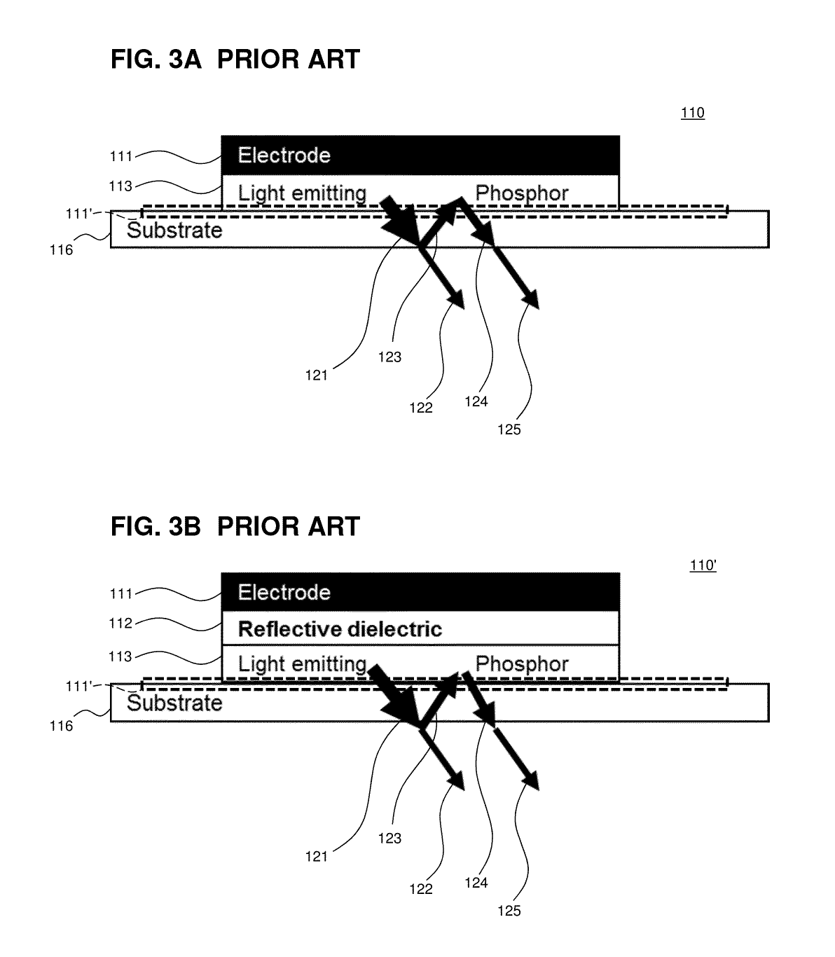

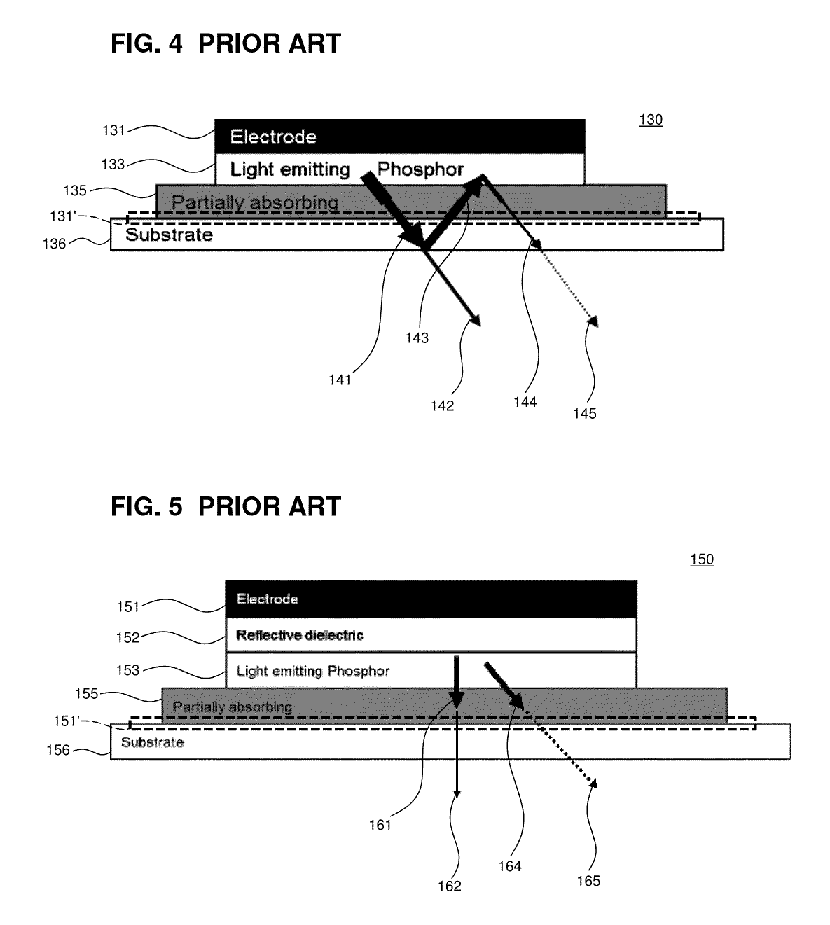

Preferred embodiments of the present invention provide a transflective display that includes a reflection layer that reflects light back in a light-emitting layer. FIG. 1A shows a preferred embodiment of the present invention in which the reflection layer is a diffuser layer 14. FIG. 1B shows a modification of the preferred embodiment of FIG. 1A that includes a reflective dielectric 12. FIG. 2 shows another preferred embodiment of the present invention in which the reflection layer is a low-refractive-index layer 34.

FIG. 1A shows a schematic view of a transflective display 10 according to a preferred embodiment of the present invention. As shown in FIG. 1A, the transflective display 10 includes an electrode layer 11, a light-emitting phosphor layer 13 (which preferably includes a fluorescent or phosphorescent material), a diffuser layer 14, a partially absorbing layer 15, and a substrate 16. The display 10 may also include a front electrode layer 11′ which, along with the electrode layer 11, can activate the phosphor(s) included in the light-emitting phosphor layer 13. The front electrode layer 11′ is preferably a transparent or substantially transparent layer that transmits at least about 80% of incident light.

The electrode layer 11 is preferably a reflective layer. Alternatively, a separate reflective layer, such as the reflective dielectric layer 12 of the modified transflective display 10′ shown in FIG. 1B, may be arranged between the electrode layer 11 and the light-emitting phosphor layer 13. Preferably, the absorbance of the partially absorbing layer 15 is controlled electrically, and the absorbance of the partially absorbing layer 15 increases as the angle of incident light becomes closer to parallel with the substrate 16. The partially absorbing layer 15 may be a polymer dispersed liquid crystal, or any other material whose transmittance changes in response to the application of an electric field. Further, the light-emitting phosphor layer 13 is preferably a mixture of a blue-emitting phosphor and/or a green-emitting phosphor with a red dye. The light-emitting phosphor layer 13 may include a mixture of electroluminescent phosphor, red fluorescent dye or pigment, and a binder material. Preferably, the light-emitting phosphor layer 13 is formed by depositing an ink using a printing process.

The diffuser layer 14 scatters incident light and is interposed between the light-emitting phosphor layer 13 and the partially absorbing layer 15. The diffuser layer 14 preferably includes a material diffused in a transparent matrix so as to scatter light that passes through it. For example, a layer of barium titanate-loaded-polyvinilidene fluoride having a thickness of about 1 μm to about 10 μm may be used for the diffuser layer 14. Other white powders (e.g., titanium dioxide) could be used in other polymer binders. The diffuser layer 14 preferably has a dielectric constant between about 5 and about 50, for example, so as to have little or no effect on electrical performance of the transflective display 10. The material of the diffuser layer 14 preferably transmits about 60% to about 70% of received light and scatters back the remaining about 30% to about 40%, for example.

As shown in FIGS. 1A and 1B, emitted light 21 which is emitted by the light-emitting phosphor layer 13 is scattered by the diffuser layer 14. Some of the scattered light passes through the partially absorbing layer 15 and the substrate 16 and is output from the transflective display 10 or 10′ as output light 22. Some of the scattered light is scattered back to the light-emitting phosphor layer 13 as reflected light 23. The reflected light 23 is converted from blue and/or green light to red light by the red dye and re-emitted toward the diffuser layer 14, by reflecting off the electrode layer 11 of FIG. 1A or the reflective dielectric 12 of FIG. 1B, as partially converted emitted light 24. A portion of partially converted emitted light 24 continues through the partially absorbing layer 15 and the substrate 16 and is output from the transflective display 10 or 10′ as partially converted output light 25. Another portion of the partially converted emitted light 24 is again reflected (not shown) at the interface between the diffuser layer 14 and the partially absorbing layer 15. It is noted that a small portion of the emitted light 21 and the partially converted emitted light 24 is absorbed by the diffuser layer 14.

Accordingly, in the transmissive mode of the transflective display 10 or 10′, the color of the total output light from the transflective display 10 or 10′ is shifted from the color which would be obtained without the diffuser layer 14 to a color of a longer wavelength (i.e. closer to the red end of the visible light spectrum). Thus, the undesirable shift to the blue end of the visible spectrum associated with known displays is significantly reduced or eliminated.

Furthermore, the effect of the diffuser layer 14 is beneficial in the reflective mode of the transflective display 10 or 10′. The diffuser layer 14 preferably is arranged to reflect some of the light incident on the transflective display 10 or 10′ before it reaches the red dye, thereby reducing the intensity of the red color compared to a display that does not include the diffuser layer 14.

FIG. 2 shows a schematic view of a transflective display 30 according to a preferred embodiment of the present invention. As shown in FIG. 2, the transflective display 30 includes an electrode layer 31, a light-emitting phosphor layer 33, a low-refractive-index layer 34, a partially absorbing layer 35, and a substrate 36. Preferably, the transflective display 30 also includes a reflective dielectric 32. The absorbance of the partially absorbing layer 35 in some circumstances can increase as the angle of incident light becomes closer to parallel with the substrate 36. Preferably, the partially absorbing layer 35 is a polymer dispersed liquid crystal (PDLC) layer. The display 30 may also include a front electrode layer 31′, which, along with the electrode layer 31, can activate the phosphor(s) included in the light-emitting phosphor layer 33. The phosphor(s) in the light-emitting phosphor layer 33 can be dyed or not dyed phosphor(s). The front electrode layer 31′ is preferably a transparent or substantially transparent layer that transmits at least about 80% of incident light.

The transflective display 30 shown in FIG. 2 includes a structure similar to that described above with respect to the transflective display 10 or 10′ shown in FIGS. 1A and 1B. However, the transflective display 30 includes a low reflective index layer 34 instead of a diffuser layer that is interposed between the light-emitting phosphor layer 33 and the partially absorbing layer 35. Further, the transflective display 30 preferably includes a reflective dielectric 32 interposed between the electrode 31 and the light-emitting phosphor layer 33, although the reflective dielectric 32 may be omitted so that light reflects off the electrode layer 31.

The low-refractive-index layer 34 includes a material with a low refractive index, such as perfluoropolymers (or copolymers of perfluoropolymers). One example of a perfluoropolymer that may be included in the low-refractive index-layer 34 is CYTOP, which is produced by Asahi Glass Co. A low refractive index in this preferred embodiment means a refractive index which is lower than each of the refractive indexes of the light-emitting phosphor layer 33, the partially absorbing layer 35, and the substrate 36. Since the refractive index of the low-refractive-index layer 34 is less than the refractive index of the light-emitting phosphor layer 33, the critical angle (i.e., the angle at which incident light undergoes total internal reflection) of the interface between the light-emitting phosphor layer 33 and the low-refractive-index layer 34 (for light emitted by the light-emitting phosphor layer 33) is less than 90° to the normal. The refractive index of the low-refractive-index layer 34 is preferably chosen to be as low as possible, and preferably falls in the range between about 1.30 and about 1.45, for example. The phosphor layer 33, the partially absorbing layer 35 and the substrate 36 may have, for example, refractive indices in the range about 1.5 to about 1.6. The effect of the low-refractive-index layer 34 is to alter the angle at which light passes through the partially absorbing layer 35.

Because the refractive index of the low-refractive-index layer 34 is lower than refractive index of the light-emitting phosphor layer 33, incident light having an angle of incidence greater than the critical angle is totally internally reflected. That is, a portion of the light emitted by the light-emitting phosphor layer 33 is internally reflected back into the light-emitting phosphor layer 33.

Light that is emitted from the light-emitting phosphor layer 33 at an angle that is normal to the substrate 36 as normal-emitted light 41 passes through the low-refractive-index layer 34, the partially absorbing layer 35, and the substrate 36 and is output from the transflective display as normal-output light 42.

Light which is emitted from the light-emitting phosphor layer 33 at an angle that is close to normal with the substrate 36 (i.e., an angle less than the critical angle of the interface between the light-emitting phosphor layer 33 and the low-refractive-index layer 34) as emitted light 43, passes through the low-refractive-index layer 34 and through the partially absorbing layer 35. However, due to the interface between the light-emitting phosphor layer 33 and the low-refractive-index layer 34, emitted light 43 is refracted such that its direction is changed to an angle closer to parallel with the substrate 36 as it passes through the low-refractive-index layer 34 as refracted light 44. Further, due to the interface between the low-refractive-index layer 34 and the partially absorbing layer 35, the refracted light 44 is refracted again such that its direction is changed to an angle closer to normal with the substrate 36 as it passes through the partially absorbing layer 35 and the substrate 36 and is output from the transflective display 30 as output light 45.

Light which is emitted from the light-emitting phosphor layer 33 at an angle that is close to parallel to the substrate 36 (i.e., an angle greater than the critical angle of the interface between the light-emitting phosphor layer 33 and the low-refractive-index layer 34) as emitted light 46, is reflected back into the light-emitting phosphor layer 33 by total internal reflection at the interface between the light-emitting phosphor layer 33 and the low-refractive-index layer 34 as reflected light 47. The reflected light 47 is either absorbed and re-emitted by the light-emitting phosphor layer 33 in a randomized direction or reflected by the reflective dielectric 32 as re-emitted/reflected light 48. Re-emitted/reflected light 48 may pass through the low-refractive-index layer 34, the partially absorbing layer 35, and the substrate 36 and out of the transflective display 30 as output light 49.

When the partially absorbing layer 35 has a greater absorbance for light which passes at an angle close to parallel to the substrate 36 than for light which passes at an angle close to normal to the substrate 36 (for example, at an angle less than the critical angle of the interface between the light-emitting phosphor layer 33 and the low-refractive-index layer 34), the overall effect is to increase the total amount of light which is output from the transflective display 30 compared to a display without the low-refractive-index layer 34.

The layers of the transflective display 30 provide high reflection efficiency and, accordingly, provide high contrast for images displayed on the transflective display 30. In particular, the high reflection efficiency is achieved by the transflective display 30 having minimal effect on light that is received by transflective display 30 from an external source. Light entering the transflective display 30 is refracted away from normal as the light passes from the partially absorbing layer 35 to the low-refractive-index layer 34. However, there is no total internal reflection of this light because the refractive index of the low-refractive-index layer 34 is greater than the refractive index of air (i.e., about 1), from where the light external to the transflective display 30 originated. There is a change in the angle of the light towards an angle closer to normal, due to refraction as the light passes from the low-refractive-index layer 34 to the light-emitting phosphor layer 33. However, this change in angle of the light is of no consequence, because the light is then scattered in the light-emitting phosphor layer 33. As this scattered light passes back through the low-refractive-index layer 34 and into the partially absorbing layer 35, the same advantageous reflection of light travelling at shallow angles is achieved in the reflective mode as is achieved in the transmissive mode of the transflective display 30.

Instead of using diffuser layer 14 or low-refractive-index layer 34, it is also possible to use a thin metallic layer (e.g., a thin silver or aluminum layer) between the light-emitting phosphor layer 13, 33 and the partially absorbing layer 15, 35 to reflect some of the light from the light-emitting phosphor layer 13, 33 back into the light-emitting phosphor layer 13, 33 and to reflect some of the external light before entering the light-emitting phosphor layer 13, 33.

The electrode layers 11 and 31 according to the preferred embodiments of the present invention preferably include materials such as carbon, silver, copper, gold, and similar conductive materials, for example. Preferably, the electrode layers 11 and 31 are formed by depositing an ink using a printing process, the ink including a conducting material, a binding material, and, optionally, a solvent (e.g., water or an organic solvent). Preferably, the printing process is a screen printing process, although other forms of printing may be used. The ink may be cured, for example, by using an ultraviolet (UV) light. The front electrode layers 11′ and 31′ according to the preferred embodiments of the present invention preferably include transparent or substantially transparent materials, for example, indium tin oxide, Poly(3,4-ethylenedioxythiophene) (PEDOT), PEDOT doped with poly(styrene sulfonate) (PSS) to form PEDOT:PSS, or a similar transparent or substantially transparent conductive materials. Preferably, the front electrode layers 11′ and 31′ include materials that allow the front electrode layers 11′ and 31′ to transmit at least 80% of incident light.

Preferably, the light-emitting phosphor layers 13 and 33 according to the preferred embodiments of the present invention are formed by depositing an ink using a printing process, such as a screen printing process, although other forms of printing may be used. Although the light-emitting phosphor layers 13 and 33 are described herein as preferably including a blue-emitting phosphor and/or a green-emitting phosphor, the light-emitting phosphor layers 13 and 33 are not limited thereto. In particular, the light-emitting phosphor layers 13 and 33 may include other light-emitting elements, for example, light-emitting diodes (LEDs), organic light-emitting diodes (OLEDs), and the other similar light emitters.

The partially absorbing layers 15 and 35 according to the preferred embodiments of the present invention are preferably electronically controlled in a similar manner in both transmissive and reflective display modes. More specifically, in both the transmissive and reflective display modes, in active areas of the display 10, 10′, or 30 which is active (i.e., areas that are generating an image that is visible to a user), the partially absorbing layer 15 or 35 is preferably controlled to increase the transmission of light. Correspondingly, in inactive areas of the display 10, 10′, or 30 (i.e., areas that are not generating an image), the partially absorbing layer 15 or 35 is preferably controlled to reduce the transmission of light. Preferably, the partially absorbing layers 15 and 35 are formed by depositing an ink using a printing process, for example, screen printing, ink jet printing, gravure printing, or any other form of printing.

The substrates 16 and 36 according to the preferred embodiments of the present invention preferably include transparent or substantially transparent materials including, for example, glass, polyethylene terephthalate (PET or PETE), polyethylene napthalate (PEN), any other polyester material, or a similar transparent or substantially transparent material.

Moreover, two or more of the layers described herein may be combined as a single layer without departing from the scope and spirit of the present invention. For example, the light-emitting phosphor layer 13 could be combined with the diffuser layer 14. Such a combined layer might be coated with a transparent or substantially transparent material so that the thickness of the combined layer is roughly equivalent to the total thickness of the two individual layers.

The preferred embodiments of the present invention provide displays with high quality output color, reflected color, and brightness, including, for example, displays that include a fluorescent dye in the phosphor layer, such as SMARTINK® displays, including those displays described in, for example, U.S. Patent Application Publication Nos. 2008/0303981, 2009/0273737, and 2011/0148807, incorporated by reference for all purposes. In particular, white portions of the output light of the displays may be closer to pure white. White color is defined according to the color co-ordinates x and y in the International Commission on Illumination (CIE) color space, and the output light of the displays described herein may be considered white according to the color co-ordinates of x=0.33 +/−0.05 and y=0.33 +/−0.05. Further, the preferred embodiments of the present invention are also applicable to other transflective display technologies.

The preferred embodiments of the present invention also provide enhanced brightness of displays that use transflective or transmissive display technology where the light-emitting layer is in contact with a partially absorbing front layer, for example, SMARTINK® displays. Furthermore, the preferred embodiments of the present invention provide a transflective display that outputs substantially the same color in the transmissive and reflective modes so that a user may reliably use the display in varying ambient light conditions. Since the reflective color of the display varies depending on ambient lighting conditions (e.g., based on the color of the light external to the display), the reflective color of the display is preferably defined as having no strong color (other than white) when viewed by a user in bright lighting conditions.

It should be understood that the foregoing description is only illustrative of the present invention. Various alternatives and modifications can be devised by those skilled in the art without departing from the present invention. Accordingly, the present invention is intended to embrace all such alternatives, modifications, and variances that fall within the scope of the appended claims.

1-21. (canceled)

22. A transflective display comprising:
a substrate;
a partially absorbing layer arranged on the substrate;
a diffuser layer arranged on the partially absorbing layer opposite to the substrate; and
an emissive layer arranged on the diffuser layer opposite to the partially absorbing layer and including a plurality of light-emitting elements that emit light of at least one color and a dye of a color other than the at least one color of the plurality of light-emitting elements; wherein
the diffuser layer is arranged to reflect some light from the emissive layer back into the emissive layer.

23. The transflective display according to claim 22, wherein the plurality of light-emitting elements of the emissive layer are light-emitting phosphors.

24. The transflective display according to claim 23, wherein:
the plurality of light-emitting elements of the emissive layer includes a blue-emitting phosphor and/or a green-emitting phosphor; and
the dye is a red dye.

25. The transflective display according to claim 22, wherein:
a portion of light emitted by the emissive layer that is incident on the diffuser layer passes through the diffuser layer, the partially absorbing layer, and the substrate; and
another portion of light emitted by the emissive layer that is incident on the diffuser layer is internally reflected by the diffuser layer.

26. The transflective display according to claim 22, wherein light reflected by the diffuser layer is shifted to a longer wavelength by the emissive layer and re-emitted into the diffuser layer.

27. The transflective display according to claim 22, wherein an absorbance of the partially absorbing layer increases as an angle of incident light becomes closer to parallel with respect to the partially absorbing layer.

28. The transflective display according to claim 22, wherein the partially absorbing layer is electrically controlled.

29. The transflective display according to claim 22, wherein the partially absorbing layer is a polymer dispersed liquid crystal layer.

30. The transflective display according to claim 22, wherein the diffuser layer includes barium-titanate-loaded polyvinilidene fluoride.

31. The transflective display according to claim 22, wherein the diffuser layer transmits about 60% to about 70% of incident light and scatters about 30% to about 40% of incident light.

32. The transflective display according to claim 22, wherein the diffuser layer has a dielectric constant between about 5 and about 50.

33. The transflective display according to claim 22, wherein the diffuser layer is a metallic layer arranged to reflect some light from the emissive layer back into the emissive layer and to reflect some external light before entering the emissive layer.

34. The transflective display according to claim 22, wherein the substrate, the partially absorbing layer, and the emissive layer each have a refractive index between about 1.5 to about 1.6.

35. The transflective display according to claim 22, further comprising:
an electrode layer arranged on the emissive layer opposite to the diffuser layer; and
a transparent or substantially transparent front electrode layer arranged between the substrate and the partially absorbing layer.

36. The transflective display according to claim 35, wherein the electrode layer and the front electrode layer are arranged to activate the plurality of light-emitting elements.

37. The transflective display according to claim 22, wherein white light output by the transflective display has color co-ordinates of x=0.33 +/−0.05 and y=0.33 +/−0.05 in the International Commission on Illumination (CIE) color space.

38. The transflective display according to claim 22, wherein the diffuser layer and either the partially absorbing layer or the emissive layer are provided in a single layer.
